(19) United States
(12) Patent Application Publication
(10) Pub. No.: US 2004/0128362 A1
(43) Pub. Date: Jul. 1, 2004

(54) Attaching files to appointments and tasks on a computer device

(76) Inventors: Yong Cui, Plano, TX (US); Roman J. Pacheco, McKinney, TX (US)

Correspondence Address: TEXAS INSTRUMENTS INCORPORATED, P O BOX 655474, M/S 3999, DALLAS, TX, 75265

(21) Appl. No.: 10/635,597

(22) Filed: Aug. 6, 2003

Related U.S. Application Data
(60) Provisional application No. 60/437,599, filed on Dec. 31, 2002.

(51) Int. Cl. G06F 15/16

(52) U.S. Cl. 709/217

(57) ABSTRACT

File attachments to appointments or tasks are provided in a software environment such as a planner or appointment book. The attachment does not necessarily include a copy of the attached file in the appointment or task. The attachments can be implemented as links or pointers to existing documents or files in the user's file system. The present invention is particularly advantageous for portable electronic devices where the conservation of memory to store the attachments is limited.

### PRIORITY CLAIM

This Application claims priority of Provisional Application 60/437,599 filed Dec. 31, 2002.

### TECHNICAL FIELD OF THE INVENTION

This invention relates to electronic computing devices, and more particularly to a method for attaching files to appointments and other tasks on the electronic computer device.

### BACKGROUND OF THE INVENTION

Prior art file attachments are typically files added to another file, such as an e-mail with an attached text document or media file. The attachment file is made part of another file or document.

A portable computer device such as a hand-held calculator, personal digital assistant (PDA) or personal learning tool (PLT) can store relatively large amounts of data, but data storage on such devices is always at a premium compared to full size computers. Prior art computers have used attachments as a mean of associating a file with another file, such as a data file with an e-mail. Prior art attachments are made by making a copy of the attached file and placing it in the host file.

### SUMMARY OF THE INVENTION

The present invention provides “file attachments” to appointments or tasks in a software environment such as a planner or appointment book. The attachments are implemented as links or pointers to existing documents or files in the user's file system. Thus, in embodiments of the present invention, the term attachment does not necessarily include the prior art implication of actually placing a copy of the attached file in the appointment or task.

Embodiments of the present invention are directed to portable electronic devices where the conservation of memory to store the attachments is particularly advantageous.

In an embodiment, the appointment or task “attachment” is a link or a pointer to a file in the user's file system.

In another embodiment, any type of file can be “attached” to the appointment or task. Applications that are registered with the operating system can be used to open attached files with the corresponding file type.

An advantage of the present invention is that users can have multiple files attached to a single appointment or task.

### BRIEF DESCRIPTION OF THE DRAWINGS

FIG. 1 illustrates a hand-held device having features according to the present invention.

FIGS. 2a-e illustrate the screen display of a hand-held computer device according to an embodiment of the present invention.

FIG. 3 illustrates a block diagram of a file system according to an embodiment of the present invention.

### DETAILED DESCRIPTION OF THE INVENTION

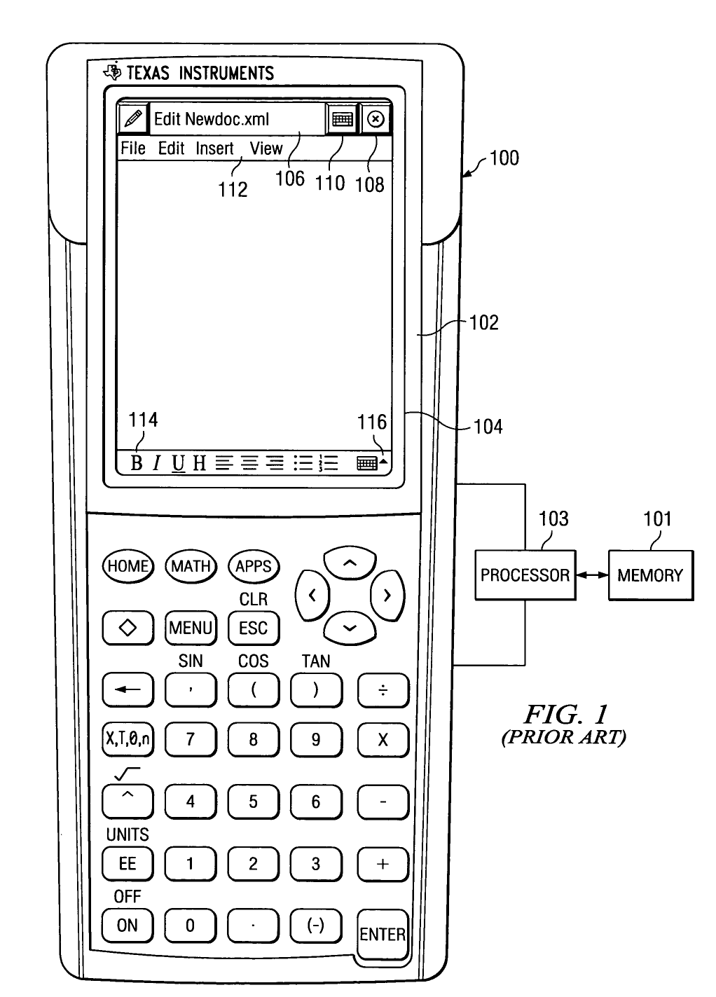

FIG. 1 illustrates a computer or hand held computing device 100 that incorporates features of the present invention. The device has a display screen 102 having a display area 104. In this embodiment, the display is a touch sensitive display that uses a stylus for input (not shown). The device executes software described herein stored in memory 101 on the micro-processor 303.

The display includes a header bar 106 that shows the current tool (in this case a compound document editor tool called “scribe”). The file name of the current open document on the display is also shown on the header bar. In addition, the header bar shows an icon for closing the tool 108 and a keyboard icon 110 to bring up a “QWERTY” keyboard on the display for input of characters with the stylus. The display area 104 further includes a top button bar 112 that has drop down menus for file, edit, insert and view functions. The display area 104 also has a bottom button bar 114 that has text formatting options, a keyboard button, and an icon 116 to pop-up another menu for inserting text symbols.

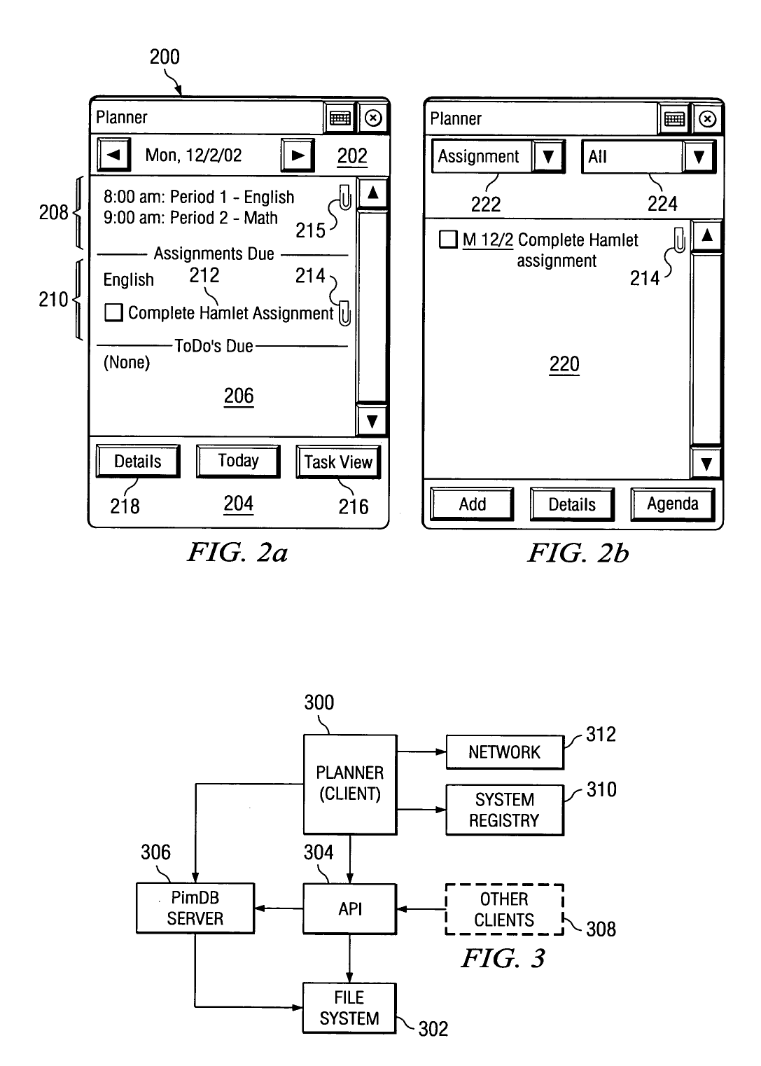

FIGS. 2a through 2d illustrate embodiments of the present invention. These figures represent screen displays for a portable computer device such as the one shown in FIG. 1. FIG. 2a shows a software application tool called “Planner.” The Planner software application is used to manage the schedule and tasks of the user. In this embodiment, the Planner is a time management application directed to a student user.

FIG. 2a illustrates a schedule view 200 of the planner application. The schedule view has a top bar 202 that shows the date of the currently displayed schedule, and has arrow buttons to move the date forward or backwards. A bottom button bar 204 has buttons for other views such as Details, Today and Task View. The details view and Task View are described further below. The Today button brings the schedule display to the current data.

The main display area of the schedule view 206 is divided into an appointment area 208 and a task area 210. The appointment area 208 shows a list of events or appointments for the current day's schedule. The task area 210 shows a list of tasks for the current day's schedule. In the illustrated embodiment directed to a student type of schedule, the tasks are divided into “Assignments Due” and “To Do's.” The distinction is that assignments are tasks for the student that must be done in response to the teacher's request, and perhaps be returned to the teacher, and the “To Do's” can be any other type of task that needs to be scheduled.

The “Assignments Due” portion of the task area includes a task called “Complete Hamlet Assignment” 212. This task has an attachment according to an embodiment of the present invention. The attachment is indicated with an attachment icon 214 next to the task description as shown. The task icon can be any suitable graphical or textual representation, here it is represented by a paper clip icon.

FIG. 2b illustrates a task view 220 of the planner application. The task view can be activated by selecting the “Task View” button 216 on the bottom button bar 204 shown in FIG. 2a. The task view 220 allows the user to work just with the tasks in the planner application. The type of task displayed is controlled with the task drop down box 222. In the illustrated embodiment, the Assignment tasks are displayed. The tasks displayed can be further restricted with the drop down box 224.

FIG. 2c illustrates a task detail view 230 of the planner application. The task view can be activated by selecting the “Details” button 218 on the bottom button bar 204 shown in FIG. 2a. The task detail view 230 shows a variety of information details about the selected task. In the illustrated embodiment, the task detail view is shown as a cascading view partially covering the previous display. Further, the task detail view in this embodiment is divided into a details portion and a notes portion. The details portion or the notes portion is selected with a tab on the top tab bar 232. The notes portion of the task details is a screen that allows the user to enter in a text note about the task. The details portion of the task can be as shown in the Figure. The task may contain such information as the category, date the task is due, reference to one or more attachments, reference to an appointment (See co-filed application), whether the task is repetitive (recurs at a given time interval), priority, task completion status, privacy status, etc.

FIG. 2d illustrates an attachment 240 associated with a task 212 in the planner application. The attachment for a task can be activated by selecting the attachment 234 in the task details view 232 shown in FIG. 2c, or by selecting the attachment icon 214 in the schedule view 200 or task view 220. In the illustrated embodiment, the attachment view is shown as a cascading view partially covering the previous display. The attachment view may be a new application program that corresponds to the type of attachment file. In the illustrated embodiment, the attachment view is a text editor program that has opened a file called “Hamlet Assignment.”

In the previously described embodiment, the attached file was associated with a task under the “Assignments Due” section of tasks. Similarly, the attachments could be made to tasks in the “To Do” portion of the task list.

In another embodiment, the attached file is associated with an appointment in the schedule planner application rather than a task. FIG. 2a shows an attachment 215 to an appointment. As described above, the attachment can be represented with a graphical icon. Also as described above, the attached document can be accessed in a similar manner by selecting the icon or by highlighting the appointment and using the details button.

In preferred embodiments of the present invention, the file attached to an appointment or task is not physically stored within the task or appointment. The attached file is stored independently and associated with the task or appointment by a link in the file system.

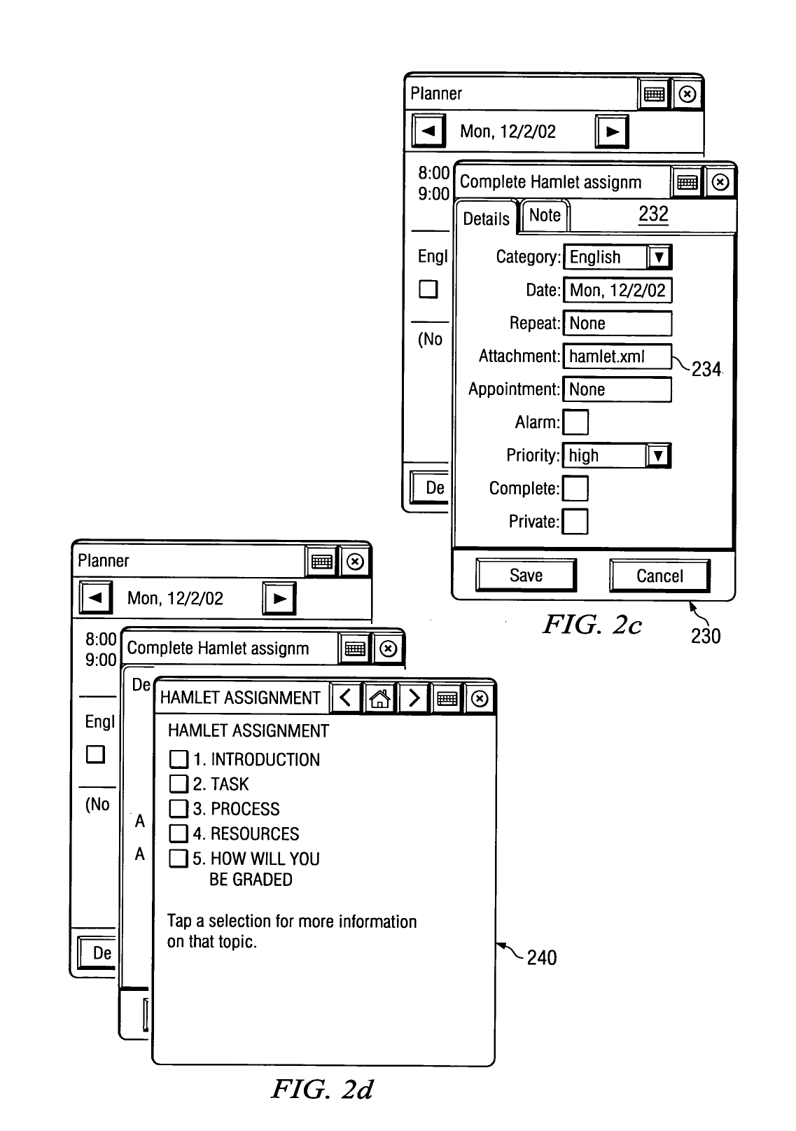

FIG. 3 illustrates a method of associating the attached files with the task or appointments according to an embodiment of the present invention. The time management software application or planner 300 accesses the file system 302 through an applications peripheral (API) interface 304. The tasks and appointment information of the planner application 300 is stored in a database 306. This database 306 includes link information for attached files stored in the file system 302. When the planner application wishes to access a file, the API 304 checks for any links associated with the file. Files that are linked to planner management entries, such as tasks or appointments would be monitored by the API. The API would perform such task as updating links, controlling deletion and copying of the file, etc. Further, if other application clients 308 seek access to linked files, the API could regulated this access also.

Again referring to FIG. 3, the planner application 300 also must access the system registry 310, which stores the registration information for all the applications which can be used to access an attached file. The registration information includes the file types that can be handled by software applications installed on the device. The planner application 300 also can access a network 310 to communicate with other computers or planners over a wired or wireless network.

Other Embodiments

Although the present invention has been described in detail, it should be understood that various changes, substitutions, and alterations could be made hereto without departing from the spirit and scope of the invention as defined by the appended claims.

The features that are the subject of the present invention could be incorporated into other into other computer based teaching tools and computers. Similarly, other embodiments include the same user interface functionality in a ROM software application package that is executed on a computer, graphing calculator or other handheld device.

What is claimed is:

1. An article comprising a medium storing software that causes a processor-based computer system to perform the following steps:
a. create a time management entry in a time management application; and
b. attach a file to the time management entry.

2. The article of claim 1 wherein the time management entry is an appointment in a time management application.

3. The article of claim 1 wherein the time management entry is a task in a time management application.

4. The article of claim 3 wherein the task is in an assignments due list of a calendar time management application.

5. The article of claim 4 wherein the time periods in the calendar time management application are class periods.

6. The article of claim 1 wherein the attached file' association with the time management entry is indicated with a graphical icon in the application near the time management entry.

7. The article of claim 6 wherein the user is able to activate the application associated with the attached file and view the attached file by selecting the graphical icon.

8. A system, comprising:
a processor;
a memory coupled to the processor; and
a. a storage medium coupled to the processor including a software program that, upon execution:
i. creates a time management entry in a time management application; and
ii. attaches a file to the time management entry.

9. The system of claim 8 wherein the time management entry is an appointment in a calendar time management application.

10. The system of claim 8 wherein the time management entry is a task in a calendar time management application.

11. The system of claim 10 wherein the task is in an assignments due list of a calendar time management application.

12. The system of claim 11 wherein the time periods in the calendar time management application are class periods.

13. The article of claim 8 wherein the attached file' association with the time management entry is indicated with a graphical icon in the application near the time management entry.

14. The article of claim 8 wherein the user is able to activate the application associated with the attached file and view the attached file by selecting the graphical icon.

15. A portable computing device, comprising:
a processor;
a memory coupled to the processor; and
a. a storage medium coupled to the processor including a software program that, upon execution:
i. creates a time management entry in a time management application; and
ii. attaches a file to the time management entry.

16. The system of claim 8 wherein the time management entry is an appointment in a calendar time management application.

17. The system of claim 8 wherein the time management entry is a task in a calendar time management application.

18. The system of claim 10 wherein the task is in an assignments due list of a calendar time management application.

19. The system of claim 11 wherein the time periods in the calendar time management application are class periods.

20. The article of claim 8 wherein the attached file' association with the time management entry is indicated with a graphical icon in the application near the time management entry.

21. The article of claim 8 wherein the user is able to activate the application associated with the attached file and view the attached file by selecting the graphical icon.
